(19) United States
(12) Patent Application Publication
(10) Pub. No.: US 2007/0233677 A1
(43) Pub. Date: Oct. 4, 2007

(54) Method and Apparatus for Matching Provision Data with Request Data in a Trading System

(75) Inventors: Christian Facciorusso, Adliswil (SZ); Yigal Hoffner, Rifferswil (SZ); Christopher Edward Sharp, Winchester (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 11/555,297

(22) Filed: Nov. 1, 2006

(30) Foreign Application Priority Data
Nov. 5, 2005 (GB) 0522635.2

(51) Int. Cl. G06F 17/30

(52) U.S. Cl. 707/6

(57) ABSTRACT

Provision data from a provider application is matched with request data from a consumer application operating in a trading environment in which third party compatibility rules are applied to matched request/provision data pairs.

### FIELD OF THE INVENTION

The present invention relates to a method, apparatus and program product for matching provision data with request data in a trading system.

### BACKROUND OF THE INVENTION

Computer-based trading systems enable merchants or providers to reveal or advertise their goods or services to potential customers or consumers via a virtual marketplace provided, for example, by a web site. Consumers can use the web site to identify advertised goods or services which they require. Commonly, such goods or services are identified when the consumer enters a description of the required good or service into a site facility. This facility matches the consumer's description to good or services advertised on the site by merchants, and returns the advertised descriptions of any matched items to the consumer. The consumer can then make a choice of which matched good or service to obtain. Such a trading site facility may be referred to a matching, matchmaking or matchmaker engine or program.

When a provider advertises goods or services on the web site, the provider may also specify a number of conditions on the provision of the goods or services. For example, the provider may specify characteristics that a consumer must possess in order to be qualified to trade. Similarly, a consumer may provide details of corresponding characteristics so as to demonstrate their qualifications to trade. Some matching engines are arranged to only return matches to a consumer where the potential trade is possible. In other words, only matches where the consumer's details meet the constraints of the provider, are passed to the consumer. The compatibility of consumers and providers is defined in compatibility rules which are applied to the consumer details and supplier constraints by the matching engine. The compatibility rules are agreed between consumers and providers for use in a given trading environment.

One problem with such an arrangement is that determining which constraints and corresponding details are compatible is a complex process. Furthermore, determining how and when the compatibility rules should be applied is also difficult and may be carried out inefficiently. In some trading situations it may by difficult to establish trust between trading parties, especially if one group, such as the providers, are dominant in producing or modifying the compatibility criteria.

### SUMMARY OF THE INVENTION

An embodiment provides a method for matching provision data from a provider application with request data from a consumer application. The provision data includes one or more elements identifying goods or services for provision by a provider and the request data includes one or more elements identifying goods or services requested by a consumer. One or more of the provision data elements is received from the provider application. Each provision data element is associated with at least one assertion relating to the provision of the good or service. One or more of the request data elements is received from the consumer application. Each request data element is associated with at least one assertion relating to a request for the good or service. Any matching pairs of request and provision data element pairs. The compatibility rule is applied to each identified matching request and provision data element pair. Any compatible matching provision data element is communicated to the consumer application.

### BRIEF DESCRIPTION OF THE DRAWINGS

Embodiments of the invention will now be described, by way of example only, with reference to the accompanying drawings in which:

FIG. 1 is a schematic illustration of a network of computers arranged to conduct a matching process in accordance with a preferred embodiment of the present invention;

FIG. 2 is a schematic illustration of data used in the matching process of FIG. 1 in accordance with a preferred embodiment of the present invention; and

FIG. 3 is a flow chart illustrating processing carried out using the data of FIG. 2 and in accordance with a preferred embodiment of the present invention.

### DETAILED DESCRIPTION OF PREFERRED EMBODIMENTS OF THE INVENTION

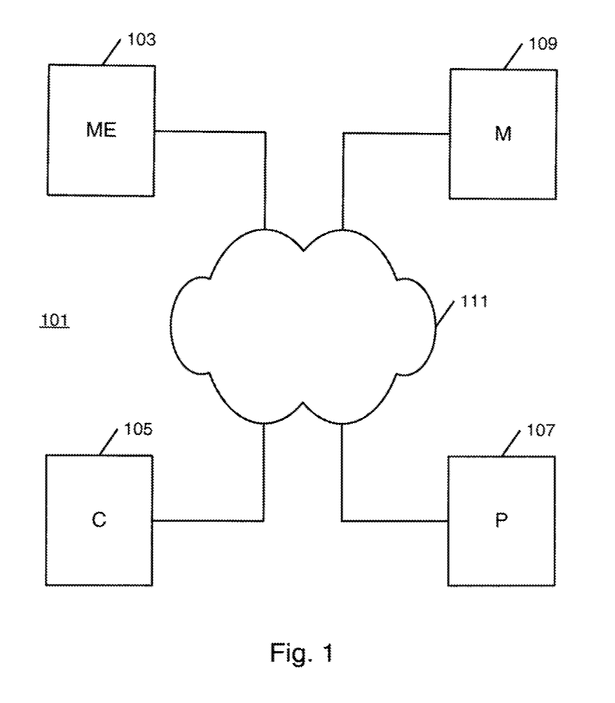

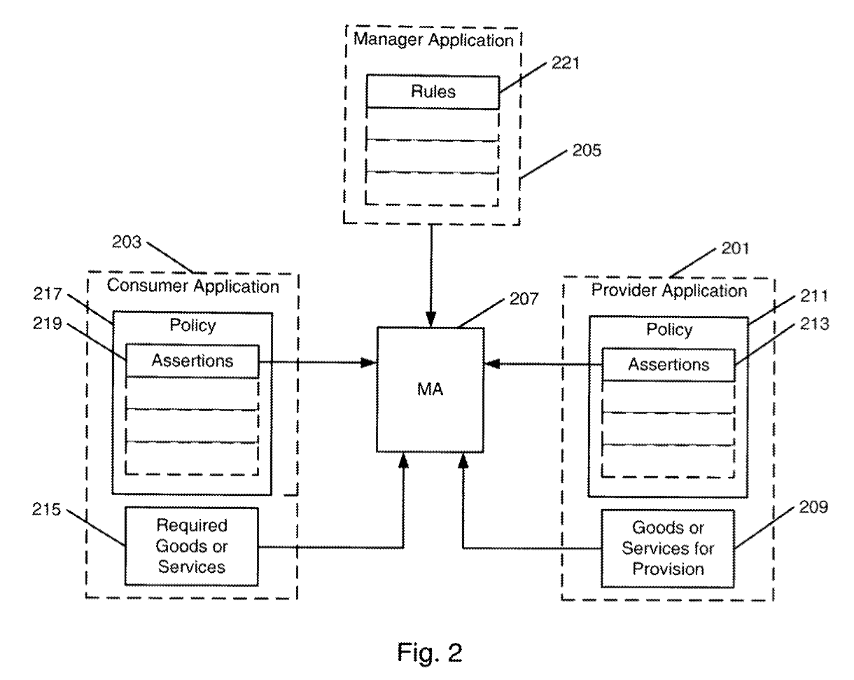

With reference to FIG. 1, a network of computers 101 includes first, second, third and fourth computers 103, 105, 107, 109 interconnected via a network 111 in the form of a wide area network (WAN). The computers together provide a trading environment or domain. The first computer 103 runs a matching application program (shown in FIG. 2) which matches a consumer's description of goods or services to descriptions of good or services advertised on the site by providers, and returns the description of the matched items to consumers. The matching application program communicates with consumers and providers via a web site. The second computer 105 runs a consumer application program (shown in FIG. 2) in the form of a web browser which enables a consumer to visit the web site provided by the first computer 103, and thereby enter into a trading relationship with one or more providers of goods or services. The third computer 107 runs a provider application program (shown in FIG. 2) which enables a provider of goods or services to advertise or offer to trade their good or services to consumers via the web site provided by the first computer 103. The fourth computer 109, runs a manger application program (shown in FIG. 2) arranged to enable a third party to apply compatibility rules to trading relationship between consumers and providers in the trading environment.

FIG. 2 shows the data used by the provider, consumer and manager applications 201, 203, 205 when interacting with the matching application 207 in the trading environment. The provider application 201 holds goods or services data 209 which describes each good or service which may be offered for trade. In addition, the provider application 201 holds a policy 211 which comprises a set of assertions or conditions 213. Each assertion 213 represents an individual behavior, preference, requirement, capability or other characteristic relating to the provider application 201. Each assertion has a label and an association data element. In order to trade, the provider application 201 passes one or more sets of data describing goods or services to the matching application 207. Each set of goods or services data is associated with one or more assertions 213. For example, the provider application 201 may advertise a good or service to trade and specify a set of assertions which govern the communications protocol that must be used in any interaction with a potential consumer application. For example, three assertions stored are in a policy named “Trading Communications” as follows:
Policy: Trading Communications
Protocol Name: 123
Header Size: 64
Quality of Service (QoS): 5

In order to trade with this provider application, a consumer application must use the protocol with the name “123” with a header size of 64 and QoS of 5. In other words, the consumer application must conform with the “Trading Communications” policy. The definitions of the assertions used are agreed and represented in a data dictionary (not shown) which is available to all parties 201, 203, 205, 207 in the trading environment.

The consumer application 203 holds goods or services data 215 which describes each good or service required by a user. In addition, the consumer application 203 also holds a policy 217 which comprises a set of assertions or conditions 219. These assertions 219 represent an individual behavior, preference, requirement capability or other characteristic relating to the consumer application 203. In order to successfully trade with the provider application 201, the consumer application 203 must hold a compatible set of assertions. Continuing the example above, the consumer application 203 also has a “Trading Communications” policy which defines the same three assertions noted above.

The manager application 205 enables the creation and storage of a set of compatibility rules 221. These rules 221 define compatible trading relationships between the provider application 201 and the consumer application 203 in terms of the assertions 213, 219 made by each party 201, 203. The rules 221 are provided to the matching application 207 by the manager application and enable third party control of the compatibility of trading relationships. The rules 221 apply to occurrences of the relevant assertions in the data dictionary. In other words, the rules 221 apply throughout the trading environment. To complete the above example, in the present embodiment, the manger application 205 provides a rule labeled the “Trading Communications” rule which is as follows:
Rule: Trading Communications
consumer.ProtocolName=provider.ProtocolName AND consumer.HeaderSize=provider.HeaderSize AND consumer.QoS<provider.QoS

The rule specifies that in order for a trading relationship between the provider application 201 and the consumer application 203 to be compatible in the trading environment, the ProtocolName and HeaderSize assertions of each party must be the same and the QoS value required by the consumer application 203 must be less than that specified by the provider application 201.

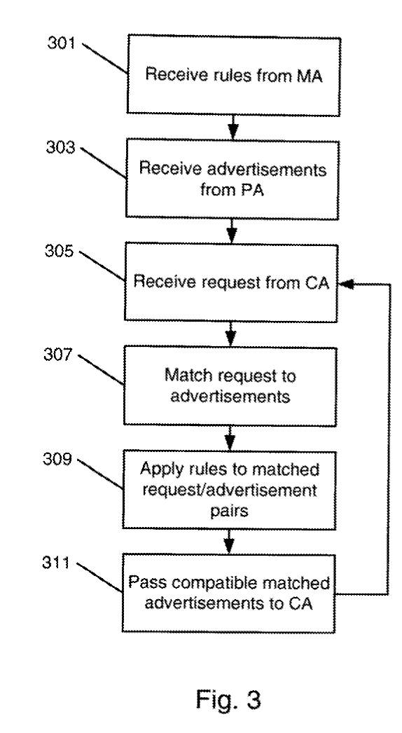

The processing of the data and assertions of the provider and consumer applications 201, 203 and the application of the compatibility rules 221 by the matching application 207 will now be described with reference to the flow chart of FIG. 3. At step 301, the matching application 207 receives one or more compatibility rules 221 from the manager application 205 and stores them for later use. Processing then moves to step 303 where one or more advertisements 209 of goods or services are received from the provider application 201 along with a set of assertions 213 that apply to each advertisement 209. This data 209 and associated assertions 213 are stored in a database held by the matching application 207 and processing moves to step 305.

At step 305, a request is received from the consumer application 203 which includes data 215 defining one or more required goods or services in association with a set of assertions 219. Processing then moves to step 307 where the matching application 207 searches its database of advertisement data 209 from the provider application 201 for matches with the goods or services data 215 described by the request from the consumer application 203. If no matches are found then this result is returned to the consumer application 203. If matches are found, processing then moves to step 309 where for each match, one or more compatibility rules 221 are applied as noted above. Once the compatibility rules 221 have been applied to all matching request/advertisement pairs then processing moves to step 311. At step 311 the advertisement data 209 from those matching pairs which passed the compatibility rule 221 is passed to the consumer application 203 to enable a selection to be made. Once a selection is made, the trading relationship is conducted between the consumer and provided parties in accordance with the policy defined by the compatible assertions 213, 219.

In the above embodiment, the compatibility rules 221 define accepted procedure for carrying out trading actions within the given environment. In other embodiments the compatibility rules are used to enforce a domain agreement within a given domain or environment, to enforce legislation on acceptable trading practices or to ensure that agreed standards are applied. Embodiments enable a third party to govern the trading relationships in a given environment, removing this obligation from either the consumer or provider parties. Compatibility rules provided by a trusted third party will enable more efficient application and modification of such rules.

In a further embodiment, a compatibility rule is provided for each assertion in the data dictionary so that each assertion can be processed separately. In another embodiment, entire policies are passed to the matching application by the provider and consumer application and compatibility rules provided which apply to such whole policies. In a further embodiment, rules are provided which apply to a group of two or more policies.

In another embodiment, further compatibility rules are supplied by the consumer application or the provider application and also applied to matching advertisement/request data pairs in addition to the compatibility rules of the manager application.

In a further embodiment, the provider or consumer applications can provide preference rules to the matching application. These rules are not defined on an environment-wide basis. The preference rules effectively provide low-level assertions. In other words, the preferences describe features which are only preferred in any trading relationship that may result from a matching request and advertisement. The matching application may be arranged to rank matched and compatible advertisement passed to the consumer application in accordance with the degree of matching of the preference rules.

In another embodiment, the compatibility rules are arranged to be applied to the consumer requests or the provider advertisements prior to a search for a match with an input request. In other words, the rules are used to filter candidates prior to the matching process.

In a further embodiment, instead of the manager application providing the rules to the matching application, the matching application is arranged to retrieve the rules created by the manager application. This rule retrieval may be performed in response to a predetermined signal or at predetermined time intervals.

In another embodiment, one or more compatibility rules are provided which check for compatibility between a feature of the product or service being offered for trade and an assertion provided by either the consumer application or the provider application. In other words, only one assertion is checked when matching consumer requests to provider advertisements. For example, if the product or service should only be supplied to a certain age group then a compatibility rule can be used to ensure that a consumer's assertion about their age is compatible with the age restricted good or service. Some consumer requests or provider offers may not be associated with an assertion in the first place.

As will be understood by those skilled in the art, the functions of domain management application could be a dedicated application or by any program capable of creating rules and publishing or transmitting them to the matching application. An example of the latter could include a word processing application used to create the rules and provide them in a file for use by the matching application. Similarly, the consumer application may be provided by a specific application or by general purpose application able to communicate with the matching application. For example, if the matching application is provided via a web site, the consumer application may be provided by a web browser.

It will be understood by those skilled in the art that the apparatus that embodies the part or all of the present invention may be a general purpose device having software arranged to provide a part or all of an embodiment of the invention. The device could be single device or a group of devices and the software could be a single program or a set of programs. Furthermore, any or all of the software used to implement the invention can be communicated via any suitable transmission or storage means so that the software can be loaded onto one or more devices.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

What is claimed is:

1. A method for matching provision data from a provider application with request data from a consumer application, the provision data comprising one or more elements identifying goods or services for provision by a provider and the request data comprising one or more elements identifying goods or services requested by a consumer, the method comprising the steps of:
a) receiving one or more provision data elements from a provider application, each received provision data element being associated with at least one assertion relating to the provision of the good or service;
b) receiving one or more request data elements from a consumer application, each received request data element being associated with at least one assertion relating to a request for the good or service;
c) identifying any matching pairs of request and provision data elements;
d) receiving a compatibility rule from a management application, the compatibility rule identifying a set of one or more assertions that define compatible request and provision data element pairs;
e) applying the compatibility rule to each identified matching request and provision data element pair; and
f) communicating any compatible matching provision data elements to the consumer application.

2. A method according to claim 1 in which the compatibility rule is applied to the request and provision data elements so as to filter the elements prior to the identifying of any matching pairs.

3. A method according to claim 2 in which the compatibility rule is received in response to an advertisement of the rule by the management application.

4. A method according to claim 3 in which the compatibility rule is received directly from the management application.

5. A method according to any one of claims 1-4 in which the compatibility rule defines one or more assertions, each of which must be associated with each of a compatible request and provision data element pair.

6. A method according to claim 5 in which one or more preference rules are received from the consumer application or the provider application and applied to each matching request and provision data element pair, each the preference rule identifying a set of one or more assertions that define preferred request and provision data element pairs.

7. A method according to claim 6 in which the received compatibility rule identifies a set of one or more assertions and a set of one or more provision or request data elements that together define compatible request and provision data element pairs.

8. Apparatus for matching provision data from a provider application with request data from a consumer application, the provision data comprising one or more elements identifying goods or services for provision by a provider and the request data comprising one or more elements identifying goods or services requested by a consumer, the apparatus comprising:
a) means for receiving one or more provision data elements from a provider application, the or each the provision data element being associated with at least one assertion relating to the provision of the good or service;
b) means for receiving one or more request data elements from a consumer application, the or each the request data element being associated with at least one assertion relating to a request for the good service;
c) means for identifying any matching pairs of request and provision data elements;
d) means for receiving a compatibility rule from a management application, the rule identifying a set of one or more assertions that define compatible request and provision data element pairs;
e) means for applying the compatibility rule to the or each identified matching request and provision data element pair; and
f) means for communicating any compatible matching provision data elements to the consumer application.

9. A method of matching data in a matching engine, the method comprising the steps of:
a) receiving one or more sets of advertisement data from a provider, one or more of the advertisements being associated with one or more assertions;
b) receiving a set of request data from a consumer, the request data being associated with one or more assertions;
c) searching the advertisement data for matches with the request data;
d) applying a rule to any matched advertisement and request data, the rule being arranged to determine whether or not the matched advertisement and request data are compatible based on one or more of the associated assertions; and
e) supplying compatible matched advertisement data to the consumer.

10. A computer program product comprising a computer usable medium embodying program instructions for matching provision data from a provider application with request data from a consumer application, the provision data comprising one or more elements identifying goods or services for provision by a provider and the request data comprising one or more elements identifying goods or services requested by a consumer, the program instructions when executed in a computer resulting in:
a) receiving one or more provision data elements from a provider application, each received provision data element being associated with at least one assertion relating to the provision of the good or service;
b) receiving one or more request data elements from a consumer application, each received request data element being associated with at least one assertion relating to a request for the good or service;
c) identifying any matching pairs of request and provision data elements;
d) receiving a compatibility rule from a management application, the compatibility rule identifying a set of one or more assertions that define compatible request and provision data element pairs;
e) applying the compatibility rule to each identified matching request and provision data element pair; and
f) communicating any compatible matching provision data elements to the consumer application.

11. A computer program product as in claim 10 wherein the compatibility rule is applied to the request and provision data elements so as to filter the elements prior to the identifying of any matching pairs.

12. A computer program product as in claim 11 in which the compatibility rule is received in response to an advertisement of the rule by the management application.

13. A computer program product as in any one of claims 10-12 in which the compatibility rule defines one or more assertions, each of which must be associated with each of a compatible request and provision data element pair.

14. A computer program product comprising a computer usable medium embodying program instructions for matching data in a matching engine, the program instructions when executed in a computer resulting in:
a) receiving one or more sets of advertisement data from a provider, one or more of the advertisements being associated with one or more assertions;
b) receiving a set of request data from a consumer, the request data being associated with one or more assertions;
c) searching the advertisement data for matches with the request data;
d) applying a rule to any matched advertisement and request data, the rule being arranged to determine whether or not the matched advertisement and request data are compatible based on one or more of the associated assertions; and
e) supplying compatible matched advertisement data to the consumer.
